(19) United States
(12) Patent Application Publication
(10) Pub. No.: US 2007/0029245 A1
(43) Pub. Date: Feb. 8, 2007

(54) Device for thickening or dehydrating sludges, watery sediments or the like, especially surplus sludge in sewage treatment plants

(75) Inventors: Horst Kuhn, Fallingbostel (DE); Claudia Steffen, Munchen (DE)

Correspondence Address: Richard A Arrett, 6109 Blue Circle Drive, Suite 2000, Minnetonka, MN, 55343-9185, US

(73) Assignee: Kuhn Umweltprodukte GmbH, Fallingbostel (DE)

(21) Appl. No.: 10/528,169

(22) PCT Filed: Jun. 17, 2002
(86) PCT No.: PCT/EP02/06649

§ 371 Date: Aug. 2, 2006

(30) Foreign Application Priority Data
Jun. 21, 2001 (DE) 201 10 292.7

(51) Int. Cl. B01D 15/00

(52) U.S. Cl. 210/263

(57) ABSTRACT

A device for thickening or dehydrating sludges, sediments from waters or the like, particularly excess sludges in sewage treatment plants, having the following features: a double-start threaded or multiple-start threaded eccentric screw pump having a pump shaft at one end and a suction duct connection for thin sludge at the other end, a drive mechanism coupled to the driving shaft, a feeding means arranged between the eccentric screw pump and the drive mechanism which is driven by the drive mechanism and is arranged in an elongate casing which is extended through by the pump shaft, with a separating device being provided in the form of a cylindrical-shaped screen in the casing to separate the sludge and liquid, a filtrate discharge outlet at the upstream side of the cylindrical-shaped screen and a thickened-sludge discharge outlet at the downstream side of the cylindrical-shaped screen, a flocculant supply device which is connected to the suction duct connection of the eccentric screw pump and/or the area which connects between the eccentric screw pump and the cylindrical-shaped screen, wherein the cylindrical-shaped screen is rotatably supported about its axis and is adapted to be rotatingly driven by the drive mechanism, and wherein the cylindrical-shaped screen has feeding elements on the inside wall to deliver the sludge towards the thickened-sludge discharge outlet.

The invention relates to a device for thickening or dehydrating sludges, sediments from waters or the like, particularly excess sludges in sewage treatment plants, according to claim 1 or 2.

It is known to perform a thickening procedure during the treatment of sewage sludge. It represents the simplest and most cost-effective manner of concentrating solids and can be performed both statically and using a machine. When the thickening procedure is static gravity is utilize in order that solid particles, the density of which is higher as compared to water, settle at the bottom of a settling basin. Static thickening may be supported by an addition of flocculation aids which reduce or eliminate the water bonding forces.

When thickening is done by a machine a distinction is made between machines which operate utilizing the natural field of gravity, e.g. screen reactors, screw presses and band thickeners, and centrifuges which generate an artificial field of gravity for a solid-from-liquid separation. A thickening procedure is capable of extracting abt. 90-95% of the water from suspensions. An extraction of water which continues to proceed further is called a dehydration. The Transition between the two processes is indistinct. When the degree of drying increases expenditure will rise superproportionally for the extraction of the water left which was behind. Accordingly, the dehydration units used according to the state of the art are designed for applying high pressures or strong centrifugal forces.

Flocculation aids are generally added into thickening or dehydration units, it being known that separation will be improved when the thickening procedure proper is preceded by an admixing line adapted to the sludge properties or a flocculation reactor.

The retention time is set in the reactor so as to achieve a floc size and mechanical stressability of the flocs which is most favourable for the succeeding thickening procedure.

The known machine devices for sludge concentration involve an expenditure in space, equipment, and cost which is not insignificant and often cannot be met by smaller-scale companies or small-capacity and medium-capacity sewage treatment plants. This also includes the energy consumed for their operation.

It is the object of the invention to provide a machine device for thickening or dehydrating sludges, sediments from waters or the like, particularly excess sludges in sewage treatment plants, in which a delivery of the sludge is coupled to its thickening or dehydration.

The object is attained by the features of claim 1 or 2.

In the inventive device, an eccentric screw pump and a feeding means are arranged in a series. The casing for the feeding means has associated therewith a separating device in the form of a cylindrical-shaped screen which separates liquid from sludge, with the casing having a filtrate discharge outlet and a discharge outlet for the concentrated sludge. In addition, a supplying device is provided for flocculants which supplies flocculants to the suction area of the eccentric screw pump and/or the area which connects between the eccentric screw pump and the feeding means. An admixing line with a feed duct can also be shifted farther ahead or a floc reactor or another type of preconditioning device may be positioned ahead.

The cylindrical-shaped screen is rotatably supported in the casing and is also driven by the drive mechanism. The driving shaft between the drive mechanism and the eccentric screw pump needs a joint because the eccentric screw pump effects a circular rotational motion in the area of the driving end. Therefore, the drive of the cylindrical-shaped screen is preferably located in that area of the driving shaft which is not pivoted along while the eccentric screw pump is being driven. The cylindrical-shaped screen is provided with feeding elements, e.g. in the form of a screw flight or segments of a screw flight. Thus, when the cylindrical-shaped screen is set into a rotary motion a delivery action is produced at the same time and the sludge is delivered away from the screw pump through the cylindrical-shaped screen. The cylindrical-shaped screen can exhibit all known screen configurations, i.e. have holes, slots or the like, be formed by a flexible cloth, be made of a plastic or be a wedge-wire metallic screen. It is understood that the feeding elements, with regard to their diameter and pitch and also the number of revolutions, will have an effect on the floc retention time, water discharge, throughput, filtrate quality, solids content of the thickened or dehydrated sludge, etc.

In the simplest case, a screen made of a flat sheet metal material is stretched around a screw which, in turn, is rotatably supported in the casing in an appropriate way.

The two processes of delivery and thickening and dehydration, when combined in a single working step, help reduce the expenditure in space, equipment, and cost.

Eccentric screw pumps and, in particular, flowable media for the delivery of solids, are known as such. It is further known to arrange a delivery screw ahead of an eccentric screw pump to supply sludge to the eccentric screw pump, but the known designs do not allow for a general or additional extraction of water. In the invention, however, the embodiment which will be described first below, has the two feeding devices in an inverse order. The eccentric screw pump serves for delivering the thin sludge, on one hand, and for thoroughly mixing the thin sludge and the flocculant, on the other. This thorough mixing can admittedly be done also in the initial area of the feeding means. However, it is also beneficial to supply flocculation aids into the area which connects between the two feeding devices.

The cylindrical-shaped screen including the feeding elements forms the separation facility proper for the flocculated sludge and liquid.

The inventive device requires little space because it dispenses with an additional pump. Likewise, the consumption of energy is lower as one pumping procedure is omitted.

Apart from thickening suspensions, the device allows to dehydrate them. The forced-delivery action of the eccentric screw pump enables high pressures to be generated when a corresponding counterpressure acts.

A corresponding counterpressure can be generated, for example, by configurations of the device with regard to the screen body construction, removal of the thickened/dehydrated sludge, delivery rate, and arrangement or design of the feeding elements of the cylindrical-shaped screen.

The invention may be applied to the thickening and dehydration of excess sludges, surface sludge mats, floating sludges, primary sludges, digested sludges or other suspensions, generally wherever a relief from volumes is desirable.

It is preferred to arrange the drive for the common shaft on the downstream-sided end of the cylindrical-shaped screen. It is also possible to dispose the drive at the opposite end.

According to the invention, to prevent the separating device from getting clogged, a scouring device is provided which directs the scouring liquid to the exit end of the cylindrical-shaped screen continuously or intermittently. A scouring strip having at least one scour nozzle may be employed which is arranged in parallel with the shaft axis. In another embodiment, provision can be made for a scouring strip having at least one scour nozzle which is movably driven to scour the screen surface continuously or intermittently. The movement of the scouring strip may be coupled to the rotation of the cylindrical-shaped screen either mechanically by effecting an appropriate gear ratio reduction, or even by an electronic drive.

The nozzles of the scouring device can be circular-jet nozzles or flat-jet nozzles as is known as such.

In an alternative solution to the inventive object according to claim 2, an eccentric screw pump and a cylindrical-shaped screen are also driven together by the same shaft. The sewage sludge which is admixed to the flocculant is supplied, via an appropriate feed duct, to the associated end of the cylindrical-shaped screen, i.e. that end of the cylindrical-shaped screen which faces away from the eccentric screw pump. A filtrate discharge outlet is located at the upstream end of the cylindrical-shaped screen whereas the thickened sludge is discharged via the eccentric screw pump.

According to another embodiment of the invention, it is also imaginable to additionally provide the pump shaft, which extends through the cylindrical-shaped screen, with feed elements up to the eccentric screw pump, preferably with a feed screw, which adds to the feeding elements in the cylindrical-shaped screen. The flight of the feed screw and the feeding elements of the cylindrical-shaped screen naturally have to engage each other without contacting each other, or have an appropriate radial spacing from each other. At this point, screw flights can extend up to the vicinity of the shaft or the vicinity of the screen as far as they are provided in either case.

An eccentric screw pump is capable of providing a relatively large delivery head. Inversely, it only has a relatively low suction head. The suction flow has to be prevented from being broken because otherwise there is a hazard of the eccentric screw pump running dry, thus destroying itself. Therefore, the device described last is an advantage in applications in which a large delivery head requires to be overcome. It can be useful here to arrange for the supply of the thin sludge via a suitable delivery pump. In the inverse arrangement which was previously described, a separate delivery pump may be completely dispensed with if there is a low suction head and a low delivery height. The benefits which are indicated in connection with the first solution described equally exist for the second solution.

The dehydration mode is also advantageous by using the second solution in which the thin sludge is supplied via a suitable delivery pump, primarily when a sludge is used which is preconditioned as a thin sludge or has been thickened already.

The invention will be described in more detail below with reference to embodiments shown in the drawings.

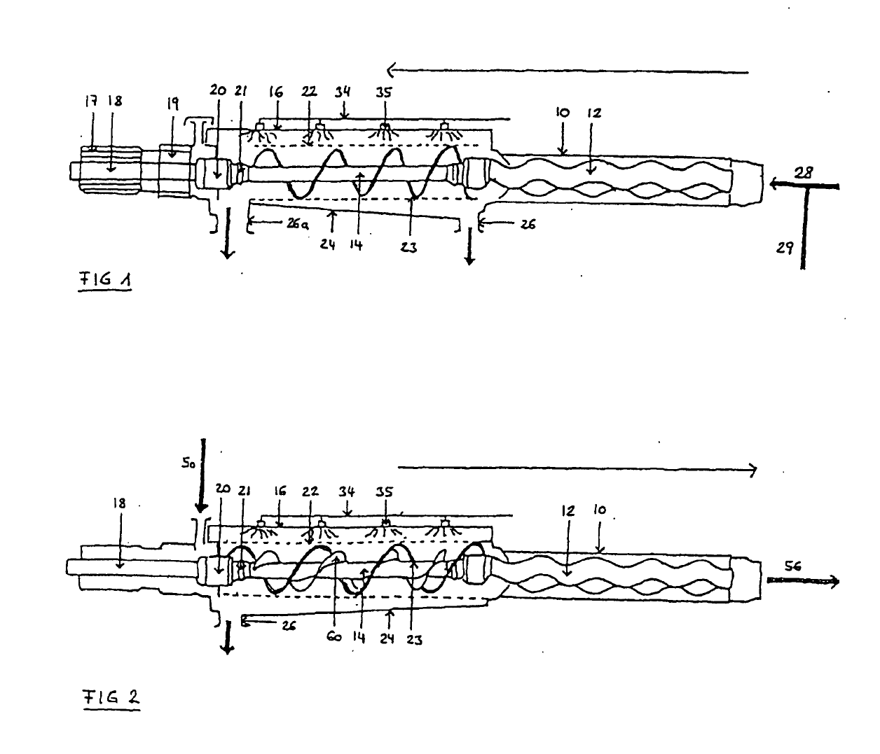

FIG. 1 in a section, schematically shows an embodiment of a device according to the invention.

FIG. 2 shows another embodiment of a device according to the invention.

Referring to FIG. 1, an eccentric screw pump 10 can be seen which can be double-start threaded or multiple-start threaded and is known as such. The worm shaft 12 of the pump 10 is coupled to a shaft 14 which is disposed in a casing 16. Shaft 14 and eccentric screw pump 10 are driven by a common shaft 18 from a driving motor 17. FIG. 1 allows to recognize a supporting mechanism 19 for the shaft 18 and a coupling 20 with a joint 21 to enable the shaft 14 to “reciprocate” with the worm gear. As an alternative, a flexible connecting rod may be employed, e.g. a Flexishaft of the Mono Pumps Company, which makes the joint unnecessary. The advantage in employing the jointless, flexible connecting rod lies in that less components are required and the jointless construction results in a larger structural length which, in turn, allows for a larger design of the separating unit (screen length).

A cylindrical-shaped screen 22 in the casing 16 is driven by a shaft 18. The inside of the cylindrical-shaped screen 22 has arranged thereon a screw flight 23 which can radially extend approximately up to the shaft 14. It may be formed from a metal or plastic and the pitch of its helix may be chosen to be different, depending on the number of pump revolutions which is suited for the delivery purposes. The length of the screw flight 23 also requires to be chosen to be adjustable to those parameters.

The bottom 24 of the casing 16 has a gradient towards the eccentric screw pump 10 and has a discharge outlet 26 for the filtrate, at its end. A discharge outlet 26a for the concentrated medium (thickened sludge) is provided at the front end of the screw flight 23.

The cylindrical-shaped screen may be made of a corrosion-resistant metallic or plastic material. The apertures may be defined by slots, gaps or the like which are arranged in the longitudinal or transverse directions. A metallic or plastic woven cloth or the like may be provided in lieu of a metallic or plastic screen.

The suction area of the eccentric screw pump 10 is supplied with thin sludge as is shown by the arrow 28. A flocculant can be supplied by means of a supplying and mixing device in this area as is shown by the arrow 29. Alternatively or in addition, the flocculant may also be supplied into the area which connects between the casing of the eccentric screw pump 10 and the casing 16. Likewise, a flocculation aid may be supplied into this area by a supplying device (not shown).

The cylindrical-shaped screen 22 requires to be scoured continuously or at intervals to prevent it from getting clogged. A stationary scouring strip for scour nozzles 35 is shown at 34 for scouring the cylindrical-shaped screen 22. The scouring strip may also be oscillatingly driven crosswise to the axis of the cylindrical-shaped screen. The support and drive therefor are not shown in detail. The control device for the movement of the scouring strips and the spraying operation are not shown either. Said device may be coupled to the rotation of the cylindrical-shaped screen 22 or may operate in a time-dependent manner.

The components shown in the embodiment of FIG. 2 largely equal those of FIG. 1 and, hence, identical parts are given identical reference numbers. However, the feeding direction is contrary in the embodiment of FIG. 2 as can be seen from the long arrows. As is shown by the arrow 50 a mixture of thin sludge and flocculant is supplied from a mixer (not shown) and is charged into the casing 16 in front of the cylindrical-shaped screen 22. The mixture is transported rightwards by means of a worm 60 on the shaft 14 and the screw flight 23 of the cylindrical-shaped screen 22, by which action filtrate is discharged via the discharge outlet 26. The concentrate is delivered by the eccentric screw pump 10 and is discharged at 56, which requires a relatively large height to be overcome, e.g. up to a higher-level storage tank.

1. A device for thickening or dehydrating sludges, sediments from waters or the like, particularly excess sludges in sewage treatment plants, having the following features:
a double-start threaded or multiple-start threaded eccentric screw pump (10) having a pump shaft (14) at one end and a suction duct connection for thin sludge (28) at the other end
a drive mechanism coupled to the driving shaft (14, 18)
a feeding means arranged between the eccentric screw pump (10) and the drive mechanism which is driven by the drive mechanism and is arranged in an elongate casing (16) which is extended through by the pump shaft (14), with a separating device being provided in the form of a cylindrical-shaped screen (22) in the casing (16) to separate the sludge and liquid
a filtrate discharge outlet (26) at the upstream side of the cylindrical-shaped screen (22) and a thickened-sludge discharge outlet at the downstream side of the cylindrical-shaped screen (22)
a flocculant supply device which is connected to the suction duct connection of the eccentric screw pump (10) and/or the area which connects between the eccentric screw pump (10) and the cylindrical-shaped screen (22), wherein
the cylindrical-shaped screen (22) is rotatably supported about its axis and is adapted to be rotatingly driven by the drive mechanism, and wherein
the cylindrical-shaped screen (22) has feeding elements on the inside wall to deliver the sludge towards the thickened-sludge discharge outlet.

2. The device for thickening or dehydrating sludges, sediments from waters or the like, particularly excess sludges in sewage treatment plants, having the following features:
a double-start threaded or multiple-start threaded eccentric screw pump (10) having a pump shaft (14) at one end and a thickened-sludge discharge outlet at the other end
a feeding means disposed in front of the eccentric screw pump which is driven by the drive mechanism and is arranged in an elongate casing (16) which is extended through by the pump shaft (14)
a separating device for the separation of the sludge and liquid in the casing (16) between the eccentric screw pump (10) and the drive mechanism
a filtrate discharge outlet at the upstream side of the separating device and a sludge charge inlet on the entrance at the pump shaft side of the eccentric screw pump (10)
and a device for the supply of a mixture of thin sludge and flocculant on the upstream side of the feeding means, wherein
the separating device has a cylindrical-shaped screen (22) which is adapted to be rotatingly driven by the drive mechanism in the casing (16) and is surrounded by the pump shaft (14), and wherein
the cylindrical-shaped screen (22) has feeding elements (23) for feeding the sludge to the charge inlet of the eccentric screw pump (10).

3. The device according to claim 1 or 2, characterized in that the feeding means are formed as a screw flight or as segments of a screw flight.

4. The device according to claim 3, characterized in that the screw flight or the segments extend approximately up to the pump shaft (14).

5. The device according to any one of claims 1 to 4, characterized in that the pump shaft (14) and the cylindrical-shaped screen (22) are adapted to be driven via a gearing assembly of the drive mechanism in such a way that the cylindrical-shaped screen (22) is adapted to be driven at a different number of revolutions and/or in a different sense of rotation with respect to the pump shaft.

6. The device according to any one of claims 1 to 5, characterized in that the region of the pump shaft (14) that is located within the cylindrical-shaped screen (22) is provided with feeding elements (60), preferably a feed screw.

7. The device according to claim 6, characterized in that the feeding elements or the screw flight extend radially approximately up to the cylindrical-shaped screen (22).

8. The device according to any one of claims 1 to 7, characterized in that the bottom (24) of the casing (16), towards the eccentric screw pump (10) or the drive mechanism, has a gradient at the end of which the filtrate discharge outlet (26) is arranged.

9. The device according to any one of claims 1 to 8, characterized in that the supplying device has a rotary-vane mixer.

10. The device according to any one of claims 1 to 9, characterized in that the cylindrical-shaped screen (22) has associated therewith a scouring device which directs scouring liquid to the outer surface of the cylindrical-shaped screen (22).

11. The device according to claim 10, characterized in that a scouring strip (34) having at least one scour nozzle (35) is stationarily arranged in parallel with the shaft axis.

12. The device according to claim 10, characterized in that a scouring strip having at least one nozzle is supported crosswise with the axis of the pump shaft and is driven by a scouring drive to scour the screen surface continuously or intermittently.

13. The device according to claim 12, characterized in that the movement of the scouring strip is coupled to the rotation of the cylindrical-shaped screens.

14. The device according to any one of claims 11 to 13, characterized in that a control device is provided for the scouring strip that controls the movement of the scouring strip and/or the discharge of scouring liquid, e.g. in a time-dependent manner.
